(19) United States
(12) Patent Application Publication
(10) Pub. No.: US 2011/0251888 A1
(43) Pub. Date: Oct. 13, 2011

(54) System and Method for Managing Tailored Marketing to Users of Wireless Devices

(76) Inventors: Patrick Lee Faith, Pleasanton, CA (US); Mark Steven Carlson, Half Moon Bay, CA (US); Krishna P. Koganti, Cupertino, CA (US)

(21) Appl. No.: 12/757,461

(22) Filed: Apr. 9, 2010

(51) Int. Cl. G06Q 30/00; G06F 15/16; G06F 17/30; G06Q 10/00; G06Q 99/00

(52) U.S. Cl. 705/14.43; 705/14.45; 707/802; 709/217; 707/E17.044

(57) ABSTRACT

A system for managing tailored marketing to users of wireless devices adapted to wirelessly access a computer network. The system includes a user database storing a plurality of user data, each user data including a user identifier and a device identifier that identifies a wireless device of a user. A management module transmits marketing information to a selected wireless device, and receives an identifier of a financial account that was used to perform a financial transaction in response to the marketing information transmitted to the selected wireless device. The module stores this identifier in the user database so as to associate the selected wireless device to the received financial account identifier. The financial account identifier can now be used to obtain personal information about the user such as the user's purchase history to generate tailored marketing information to the selected wireless device.

### FIELD OF THE INVENTION

The present invention relates to a data processing system, and more particularly to a system for managing tailored marketing to users of wireless devices adapted to wirelessly access a computer network.

### BACKGROUND OF THE INVENTION

As technology advances, more and more people are expected to carry wireless devices that are capable of wirelessly accessing a public computer network such as the Internet. These Internet-capable wireless devices include cellular phones, radios, PDAs, or other wireless devices enabled with a TCP/IP based protocol functionality. The TCP/IP protocol functionality enables the wireless devices to communicate with a content server through WiFi, WiMax, or other network technology means. In addition to handheld portable wireless devices, such wireless devices may also be built into an automobile so that passengers can download content such as audio and video and play them through the wireless device.

Although the screens of the wireless devices may be very small, they can display rich multimedia contents for the user of the wireless devices. The multimedia content may include, but is not limited to, data such as news, voice-over-IP, photographs, graphics, streaming music, SMS text, streaming video and the like.

These multimedia-enabled wireless devices provide an opportunity for merchants to send marketing information such as coupons and special offers. However, a general advertising campaign through the Internet has been known to generate very low response rates.

Thus, it would be desirable to provide a system and method for more effectively sending marketing information which are tailored to individual users of the wireless devices.

### SUMMARY OF THE DISCLOSURE

According to one aspect of the present invention, a system for managing tailored marketing to users of wireless devices is provided. The system includes a user database storing a plurality of user data. Each user data includes a user identifier and a device identifier that identifies a wireless device of a user. The management module is capable of transmitting marketing information to a selected wireless device and receiving an identifier of a financial account that was used to perform a financial transaction in response to the marketing information transmitted to the selected wireless device. The management module is further capable of storing the received financial account identifier in the user database so as to associate the selected wireless device to the received financial account identifier and using the association in generating tailored marketing information to the selected wireless device.

According to another aspect of the present invention, a method for managing tailored marketing to holders of wireless devices adapted to wirelessly access a computer network is provided. The method involves transmitting marketing information to a selected wireless device and receiving an identifier of a financial account that was used to perform a financial transaction in response to the marketing information transmitted to the selected wireless device. The method further involves storing the received financial account identifier in a user database so as to associate the selected wireless device to the received financial account identifier, wherein the user database storing a plurality of user data with each user data including a user identifier and a device identifier that identifies a wireless device of a user, the association being used to generate tailored marketing information to the selected wireless device.

### BRIEF DESCRIPTION OF THE DRAWINGS

FIG. 1 is a block diagram of an exemplary tailored marketing management system.

FIG. 2 illustrates a block diagram of a management computer that stores and executes a tailored marketing management module.

FIG. 3 illustrates the data structure of a user database.

FIG. 4 illustrates a display of a web interface module on a wireless device.

FIG. 5 illustrates a method of subscribing to multimedia content and receiving advertising on users' wireless devices.

FIG. 6 illustrates a wireless device user strolling past a set of merchant stores.

FIG. 7 illustrates a method of monitoring financial transactions from a user of a wireless device.

FIG. 8 illustrates a method of associating a user's financial account to the user's wireless device.

FIG. 9 illustrates a method for managing tailored marketing for a user of a wireless device once at least one financial account of the user is known.

FIG. 10 illustrates an alternative method of subscribing to multimedia content and receiving advertising on users' wireless devices.

FIG. 11 illustrates an alternative method for managing tailored marketing for a user of a wireless device once at least one financial account of the user is known.

### DETAILED DESCRIPTION OF THE INVENTION

For purposes of illustration and clarity, the tailored marketing feature of the present invention will be discussed in the context of delivering an advertising coupon to a user's wireless device to entice that user to perform a transaction with her credit card. However, persons of ordinary skill in the art will appreciate that the novel features disclosed herein apply to all types of marketing information including, but not limited to, special sales, promotions, brand-awareness building or the like. In addition, persons of ordinary skill in the art will appreciate that instead of a credit card, any type of a financial presentation device can be used to perform a financial transaction with a merchant. A financial presentation device is a device that can be presented to a seller of goods or services for payment, and includes, but are not limited to, credit cards, debit cards, prepaid cards, electronic benefit cards, charge cards, virtual cards, smart cards, key chain devices, personal digital assistants, cell phones, and stored value devices.

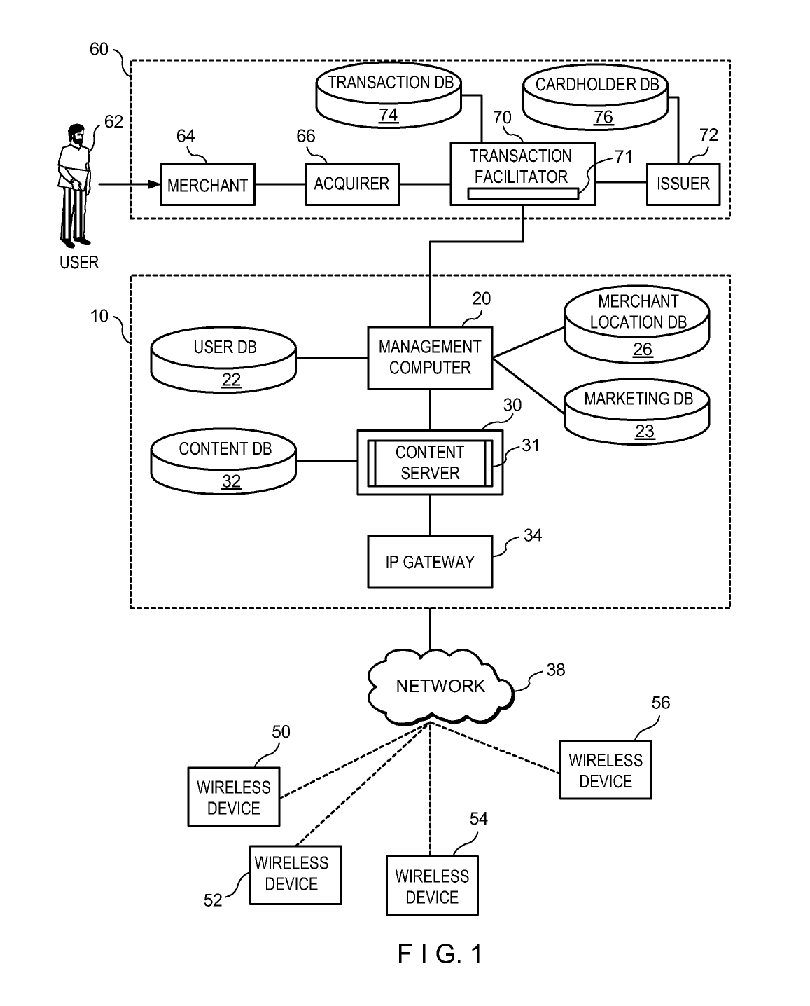

An exemplary block diagram of the above described invention featuring a tailored marketing management system is shown in FIG. 1. The tailored marketing management system 10 contains a management computer 20 and a content server 30 in communication with each other. The management system 10 also contains a set of databases that are in communication with the management computer or the content server. The set of databases includes a user database 22, merchant location database 26 and a marketing database 23 all in communication with the management computer 20. The content server 30 is in communication with a content database 32.

The user database 22 stores user specific information including the user's log-in and device ID as shall be described in detail herein below. The merchant location database 26 stores the geographical locations of merchants participating in the targeted marketing program. The marketing database 23 stores coupons as marketing information to be transmitted to wireless devices 50-56 as well as the coupon selection criteria which may be based on user's personal information or location of the wireless device 50 or both. The content database 32 stores multimedia content data such as news, photographs, graphics, streaming music, streaming video and the like.

In one embodiment, the marketing database 23 stores merchant provided coupons and merchant provided selection criteria while in another embodiment, the database stored issuer provided coupons and issuer provided selection criteria. For example, an issuer provided coupon may be double reward points for qualifying transactions during a predetermined marketing period.

The management system 10 may be accessed by any authorized user to identify and manage the marketing information for transmitting tailored marketing information to the wireless devices used by cardholders or users.

The content server 30 of the tailored marketing management system 10 is in communication with a group of wireless devices 50, 52, 54, and 56 through a computer network 38. In the embodiment shown, the network 38 includes the Internet and the management system 10 communicates with the wireless devices through an IP (Internet Protocol) gateway 34 connected to the Internet. However, the network 38 may include a combination of private networks such as a cell phone network and public networks to provide many different ways for accessing the management system 10 or the content server 30.

In one embodiment, the content server 30 includes a web interface module 31 designed to stream music or video content stored in the content database 32 through the network 38 to wireless devices belonging to subscribers of such services. The content server 30 may allow users to effortlessly subscribe to such content streaming services with only a user id and password without providing any more information in return for showing advertisements on the display 37 of the subscribers' wireless devices 50, 52, 54, and 56.

As shown in FIG. 1, a processing network system 60 includes several entities. The entities of the processing network system include a merchant 64 that conducts financial transactions with users 62 using their financial presentation devices such as a credit or debit card to purchase an item of goods or services, an acquirer 66 that receives transaction authorization requests from the merchant and transmits the same to an issuer 72 for approval through a transaction facilitator 70. The transaction facilitator 70 is an entity such as VISA® or MASTERCARD® that acts as a switch between the acquirer 66 and issuer 72 for routing messages therebetween for purposes of authorization, clearing and/or settlement of financial transactions.

After the authorization request is routed to the appropriate issuer 72 that issued the card, the transaction facilitator 70 receives a response from that issuer as to whether the authorization request is approved or rejected. The transaction facilitator 70 includes a transaction database 74 for storing all financial transactions being routed. Further, the issuer 72 includes a cardholder database 76 that stores cardholder information such as name and address, and credit limit. A monitoring module 71, whose function will be described later herein, is typically a software program that is executed by the transaction facilitator 70.

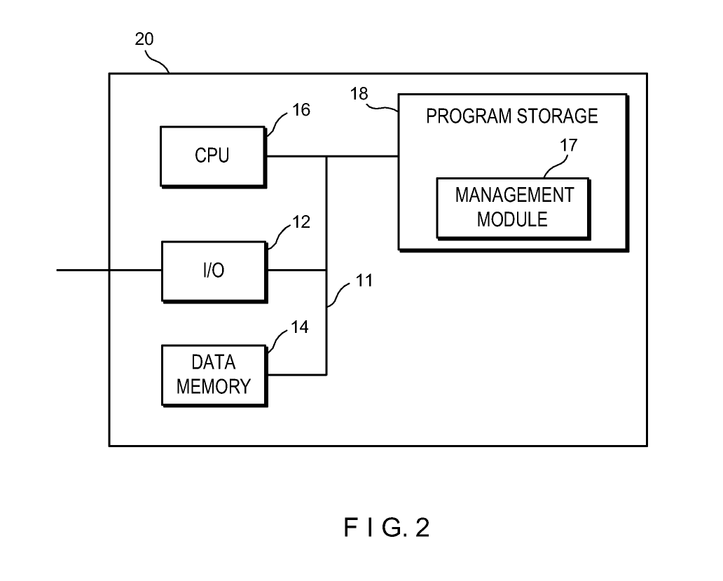

Referring now to FIG. 2, the management computer 20 of the present invention manages the selection and transmission of marketing content stored in the marketing database 23 to each individual wireless device 50-56 that are logged in to the content server.

The management computer 20 is connected to and communicates with the content server 30 and the transaction facilitator 70 including the monitoring module 71 through an I/O interface 12. While the content server 30 is streaming audio or video content to various wireless devices 50, 52, 54, and 56 that are logged in to the server, the management computer 20 may direct the content server 30 to send marketing information to those wireless devices through the IP gateway 34. The management computer 20 of FIG. 2 includes memory storage 14, processor (CPU) 16 and program storage 18, all commonly connected to each other through a bus 11. The program storage 18 stores, among others, a tailored marketing management module or program 17. Any of the software program modules in the program storage 18 are transferred to the memory 14 as needed and is executed by the CPU 16. Similarly, the content server 30 as well as any computer of merchant 64, acquirer 66, transaction facilitator 70 and issuer 72 will have the same or similar components as the system 20.

Both the management computer 20 and the content server 30 can be any computer such as a personal computer, minicomputer workstation or mainframe, or a combination thereof. While the management computer 20 and the server 30 are each shown, for illustration purposes, as a single computer unit, both the management computer 20 and the server 30 may comprise a group/farm of computers which can be scaled depending on the processing load and database size.

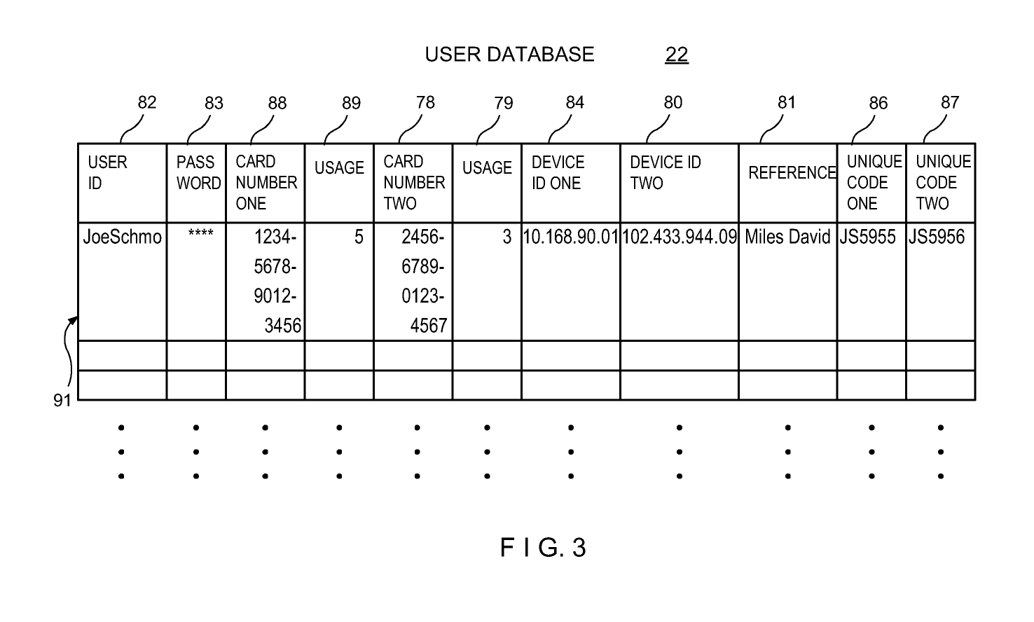

As will be explained in more detail later herein, FIG. 3 shows one example of a data structure of a record 91 in the user database 22. The user record contains the following fields: user ID 82, user password 83, card number one 88, its usage 89, card number two 78, its usage 79, device ID one 84, device ID two 80, preference 81, unique code one 86, and unique code two 87, among others. Each record in the database 22 may be accessed by the management computer 20 using any field.

As a subscriber, a user can log in to the content server 30 by sending through the wireless device 50 the user's unique user ID 82 and password 83. The management computer 20 accesses the user's record using the received user ID 82 and retrieves user data including the user preference 81. Although the example in FIG. 3 shows a simple preference field 81 of just one name, it can be a complex field consisting of a plurality of fields. For example, the preference field can store multiple artists, multiple music types, etc.

Based on the retrieved preference the management computer 20 may request additional information to select the appropriate content to transmit to the wireless device 50. This can occur when, for example, more than one artist is listed in the preference. Based on the determined preference by the computer 20, the web interface module 31 of the content server 30 streams the preferred content to the user's particular wireless device 50.

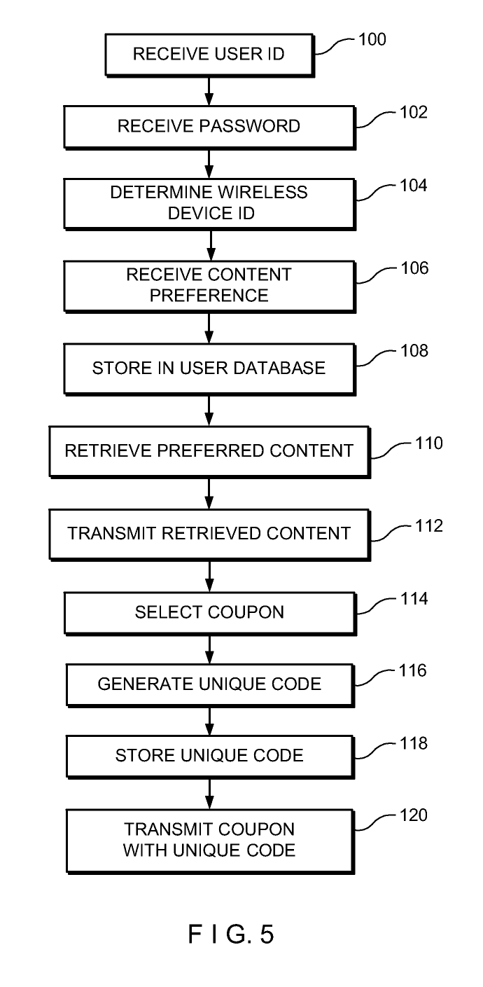

A method of offering multimedia content to users of wireless devices as part of managing a tailored marketing campaign to users of wireless devices will now be described with reference to FIG. 5. The method is part of the management module 17 which is executed by the CPU 16 of the management computer 20.

Steps 100-108 of FIG. 5 illustrate one way for a new user to subscribe to the portal website maintained by the content server 30. A user accesses the website of the content server 31 either through a wireless device 50 or home computer. In steps 100 and 102, the management module 17 receives a user ID 82 and an optional password 83 from the user. The password 83 in some embodiment is optional because it makes subscribing to the server 30 website easier and convenient.

In step 104, the management module 17 obtains a unique device identifier (preferably an identifier that uniquely identifies the device 50 among the subscribed devices). The device identifier can be one of many different types as can be appreciated by persons of ordinary skill in the art. For instance, the device identifier may be a string of characters such as an IP address, a MAC address, ESN, a HSM (Hardware Security Module) promoted by the Trusting Computing Standards group or the like. In addition, the device 50 may be configured to actively provide the device identifier recognizable by the management module 17. For instance, the device 50 may transmit a one-time usage or a dynamically changing device identifier that synchronizes with an ID functionality provided at the management computer 20. Such examples include a token code, soft key, RSA key, a cookie text, or others.

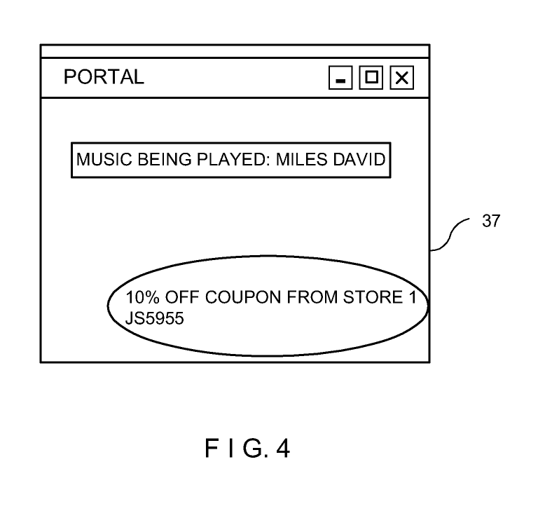

If the user 62 is accessing the content server 30 through the Internet 38, the web interface module 31 works in conjunction with the tailored marketing management module 17 to generate webpages (e.g., HTML, XHTML and XML pages) to be displayed in the display 37 of the wireless device 50 (FIG. 4).

In step 106, the module 17 requests and receives the user's content preference, e.g., Jazz music or favorite artist.

Once all of the user information have been gathered, the module creates a user record 91 in the user database 22 and stores user ID 82, optional password 83, device ID one 84 for the wireless device 50 and user preference 81 in the record.

If the user has already subscribed to the service offered by the server 30, then steps 106 and 108 are skipped.

In step 110, the management module 17 instructs the content server 30 to retrieve the preferred content, and in step 112, to transmit the retrieved content to the wireless device 50 for playback by the wireless device. As can be appreciated, subscribing to the content website offered by the content server 30 requires nothing more than a user ID and an optional password without requiring any personal information about the user to make it very easy and non-intrusive for the user to subscribe to the website so long as the user agrees to receive advertising on the wireless device.

While the content server 30 is streaming music to the wireless device 50, in step 114, the management module 17 selects and retrieves marketing information such as a coupon, from the marketing database 23. At this stage, without knowing anything about the user 62, except for the type of the wireless device and its possible location from its unique ID 84, the selected coupon is a general coupon that is not targeted with any personal information about the particular user. The selected coupon can be supplied by a merchant, an issuer or by the transaction facilitator 70 itself.

In step 116, the module 17 generates a unique code (or a unique coupon code) that can be associated to the wireless device 50 and stores the code in the unique code fields 86, 87 of the user record 91 associated with the user 62 in the user database 22 (step 118). For example, a unique code one 86 of JS5955 was generated for user ID of “JoeSchmo” in FIG. 4. The unique code one 86 is used later in associating a financial transaction performed by the user 62 to the wireless device 50 and the user ID 82, which will be explained later herein in detail. In step 120, the module 17 combines the selected coupon with the unique code one 86 and transmits the combination to the unique wireless device 50 for display on its display 37 (shown in FIG. 4).

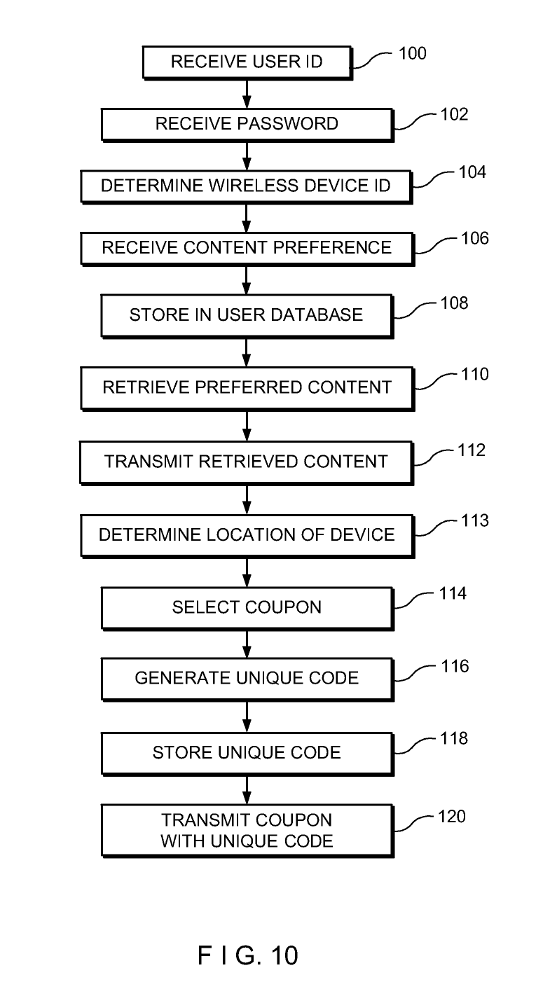

FIG. 10 illustrates an alternative method of subscribing to multimedia content and receiving advertising on users' wireless devices. The steps of FIG. 10 are substantially similar to those of FIG. 5, except the addition of step 113. In step 113, the module 17 determines the location of the particular device for the device identifier received in step 104. The location of the wireless device 50 can be determined in a well known manner. For example, the location determination can be performed by associating a geographic location to: the Internet Protocol address, Wi-Fi connection location, or GPS coordinates transmitted by a GPS locator chip inside the wireless device 50.

In step 114 of FIG. 10, the management module 17 selects and retrieves marketing information such as a coupon, from the marketing database 23 based on the determined location. For example, the module 17 can determine the possible merchants that are located near the wireless device 50 location based on the merchant location database 26 and select an appropriate coupon available from the nearby merchants. Although the selected coupon is a general coupon that is not targeted with any personal information about the particular user, it is at least location specific which will increase the chance that the user will take advantage of the coupon. As with FIG. 5, the selected coupon in step 114 of FIG. 10 can be supplied by a merchant, an issuer or by the transaction facilitator 70 itself. It may also be jointly provided by both the merchant and issuer as part of a prearranged program.

As illustrated by FIG. 4, the webpage displayed in the display 37 includes a coupon for a 10% off on any purchase of product from store 1 and a unique code of JS5955. Although the unique code is displayed in the display 37 of the wireless device 50, it can be hidden or embedded into the coupon image. FIG. 4 also shows an identification of the multimedia content (i.e., music by Miles David) being played in the wireless device 50.

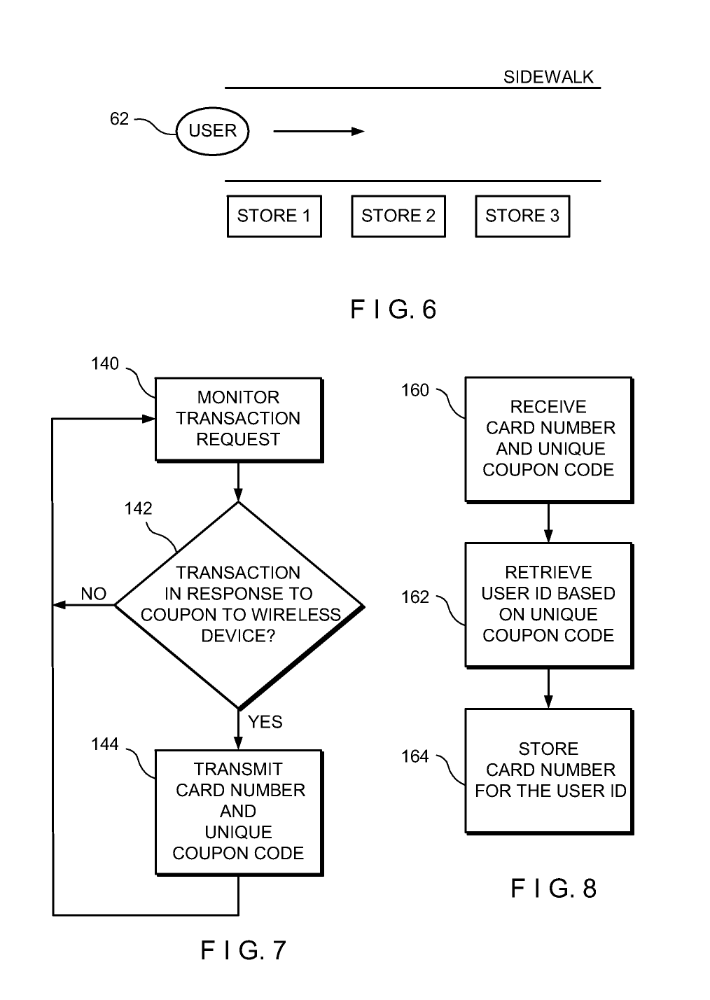

As shown in FIG. 6, assume that the user 62 is walking on a street sidewalk and is passing by a number of stores (store 1, store 2, and store 3) while the coupon is being displayed in the user's wireless device 50 and while the user 62 is listening to the streaming music. Assume further that the user 62 views the coupon and decides to use it.

Accordingly, the user 62 visits store 1 (merchant 64) and pays for a product with her credit card. The unique code 86 can be provided to the merchant 64 manually by reading the number or by entering the number into a POS terminal at the merchant location. Alternatively, the unique code 86 can be automatically provided by the wireless device 50 to the POS terminal in a contactless manner.

The merchant 64 then forwards the unique code 86 and credit card number to the transaction facilitator 70 through the acquirer 66 which can be a part of a transaction authorization message for obtaining authorization for the credit card transaction.

FIG. 7 illustrates a method of monitoring financial transactions from a user of a wireless device by the monitoring module 71 running in a computer of the transaction facilitator 70. The monitoring is preferably done in real-time. The monitoring module 71 monitors all transaction authorization messages being transmitted from the merchants 64 to retrieve any unique code contained in the transaction authorization message (step 140). In step 142, the module 71 determines whether the transaction associated with the transaction authorization message is in response to a coupon that was transmitted to the wireless device. In one method, the module determines that the transaction is, in fact, in response to a coupon that was transmitted to the wireless device if the unique coupon code field contained in the transaction authorization message is greater than zero. In another method, the module 71 stores a copy of all unique codes that are stored in the user database 22 and determines a match between the stored unique codes and the coupon code contained in the transaction authorization message.

If the monitoring module 71 determines that the transaction is in response to a coupon that was transmitted to the wireless device, then the module 71 transmits the card number and the unique code contained in the transaction authorization message to the management module 17 (step 144). If not, control passes to step 140 where the module 71 continues to monitor other transaction authorization messages being transmitted from the merchants 64. After step 144, control returns to step 140 where the monitoring module 71 continues to monitor for transactions that used the transmitted coupon.

Referring now to FIG. 8, the management module 17 receives the card number and the unique code from the monitoring module 71 (step 160). In step 162, the module 17 queries the user database 22 to retrieve the user ID 82 associated with the received unique code. The module 17 then stores the card number for the user ID 82 in the card number one field 88 of the user's record 91 (step 164) so that the user ID and the wireless device for the user are now associated with the user's credit card account number.

Prior to the association, the management computer 20 knew very little about the user except the user ID, password and wireless device identifier. Consequently, any type of coupons that were transmitted to the wireless device is unlikely to be effective.

After the association, however, the management computer 20 now can obtain a wealth of personal information about the user 62. Specifically, with the card account number of the user 62, the management computer 20 can access the transaction history in the transaction database 74 to obtain the user's purchase history and preferences. The management computer 20 can also obtain cardholder information from the cardholder database 76 of the issuer 72 such as residential address, age, annual income, family members and the like. Armed with all the knowledge about the user 62, the management computer 20 can now tailor selection of coupons based on some personal information about that user.

In addition, management computer 20 may store in fields 79 or 89 the number of times that a particular credit card has been used to purchase items in response to a coupon transmitted to her wireless device. As the number of usage for a particular associated device increases, the management computer 20 may establish a level of trust for the associated device 50 as belonging to an authorized user/cardholder.

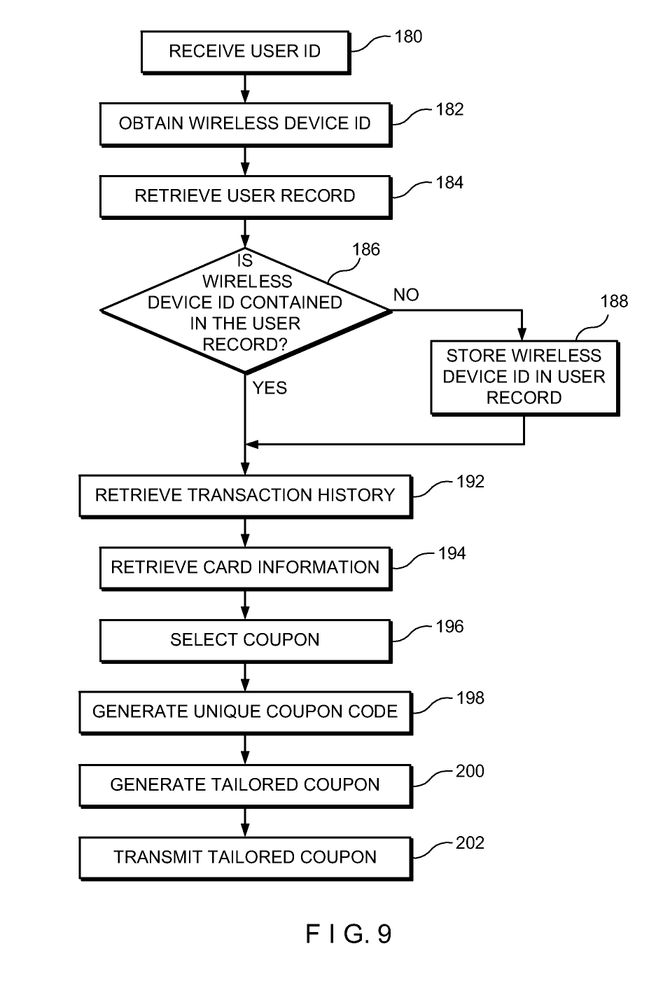

FIG. 9 illustrates the method for managing tailored marketing for a user of a wireless device once at least one financial account of the user is known. Assume that the user 62 has already used a transmitted coupon as described above and the management module 17 has associated the user's financial account number with the user's wireless device 84.

Referring now to FIG. 9, the management module 17 receives the user ID 82 (step 180) from the user 62 and automatically obtains the unique device identifier for the wireless device ID one 84 using the methodology described above (step 182). In step 184, the management module 17 retrieves the associated user record 91 from the user database 22 utilizing the received user ID 82 (or the device identifier).

In step 186, the management module 17 determines whether the device identifier obtained in step 182 is already contained in the retrieved user record 91. If the device identifier is not contained in the user record 91, the management module 17 assumes that the user 62 is using a different wireless device and stores the new device identifier in device ID two field 80 of the user record 91 (step 188). Although the user database 22 is shown to accommodate only two wireless devices, it can be easily redesigned to accommodate any number of wireless devices of the user 62. Thus, even when the user 62 switches to a different wireless device, the user record still associates the different device to the same financial account number for the user 62. Subsequently, the control passes to step 192.

If the device identifier obtained in step 182 is already contained in the user record 91, the management module 17 executes step 192. In step 192, the management module 17 may retrieve the transaction history from the transaction database 74 based on the credit card account number contained in the user record that has been retrieved in step 184. Optionally, in step 194, the management module 17 may also retrieve the cardholder information from the cardholder database 76 based on the credit card account number of the user 62.

In step 196, the management module 17 selects a coupon based on personal information obtained from steps 192, 194 or both. For example, a selection criteria for a high end HDTV coupon may be any credit card user who has spent more than $100 in movie rentals in the past six months (which comes from the retrieved transaction history) and whose annual income is greater than $150,000 (which comes from the retrieved cardholder information).

The selected coupon can be supplied by a merchant, an issuer or by the transaction facilitator 70 itself. It may also be jointly provided by both the merchant and issuer as part of a prearranged program.

Once an appropriate coupon for the user 62 has been selected, the module 17 generates a unique code that can be associated to the wireless device 52 and stores the code in the unique code one field 86 or the unique code two field 87, depending on the device identifier obtained in step 186, in the user record 91 associated with the user 62 in the user database 22 (step 198).

In step 200, the management module 17 generates a tailored coupon by combining the selected coupon with the generated unique code. In step 202, the management module 17 transmits the tailored coupon to the wireless device 52.

As the user 62 has now received an offer which has been specifically tailored to her needs, interests or preferences, the transmitted offer is much more likely to be utilized by the user than before. The present invention also benefits the transaction facilitator 70. As more transactions are performed by the users as a result of the tailored marketing program, the transaction facilitator 70 receives additional income in the form of interchange fees. Moreover, the transaction facilitator 70 can analyze the success or failure of a particular tailored marketing program by tracking the users' response rate for the program, which allows optimization of the programs to drive increased sales and card usage.

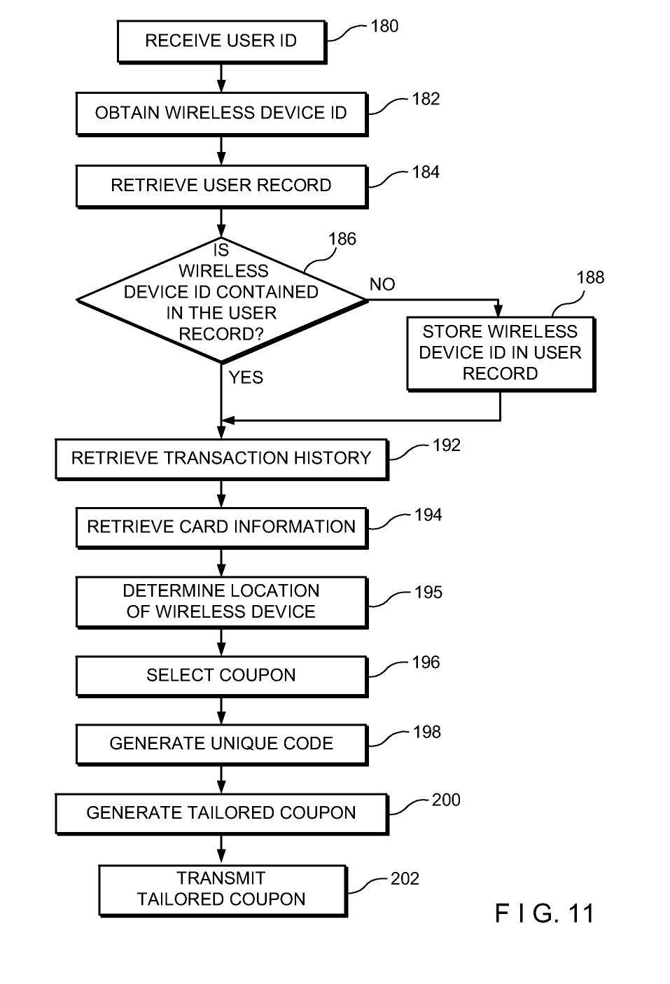

FIG. 11 illustrates an alternative method for managing tailored marketing for a user of a wireless device once at least one financial account of the user is known. The steps of FIG. 11 are substantially similar to those of FIG. 9, except the addition of step 195. In step 195, the management module 17 determines the location of the particular device 50 for the device identifier received in step 182 in a manner as discussed above with reference to step 113 of FIG. 10.

In step 196, the module 17 then selects a targeted coupon based on the location of the wireless device 50 and optionally based on personal information (e.g., zip code, annual income, spending history, etc.) obtained from steps 192 and 194.

For example, assume that the management module 17 has determined from the merchant location database 26 that the user is located near XYZ flower shop which is participating in the targeted marketing program. The module 17 then looks for any coupon available from XYZ shop from the marketing database 23. The coupon may be a 20% discount offer for two dozen roses. The management module 17 can also analyze the birthday of a spouse of the user from the retrieved personal information. If the birthday of the spouse falls within a week from today, the management module may select the 20% discount coupon as a highly targeted coupon. As can be appreciated, the response rate for such a specifically targeted coupon is substantially higher than a generic one.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A system for managing tailored marketing to users of wireless devices adapted to wirelessly access a computer network, comprising:
a user database storing a plurality of user data, each user data including a user identifier and a device identifier that identifies a wireless device of a user;
a management module executable by a processor, the management module being adapted to:
transmit marketing information to a selected wireless device;
receive an identifier of a financial account that was used to perform a financial transaction in response to the marketing information transmitted to the selected wireless device;
store the received financial account identifier in the user database so as to associate the selected wireless device to the received financial account identifier, the association being used in generating tailored marketing information for transmission to the selected wireless device.

2. The system according to claim 1, further comprising:
a content server that maintains a content website on the Internet, the content website being adapted to transmit to the selected wireless device, content selected by the user of the wireless device.

3. The system according to claim 2, wherein the management module allows the user to log in to the content website with only the user identifier without using a password.

4. The system according to claim 2, wherein when the user logs in to the content website using a user identifier and another wireless device other than the selected wireless device, the management module stores in the user database a second device identifier that identifies the another wireless device to associate the received financial account identifier to the another wireless device.

5. The system according to claim 1, wherein the wireless device identifier is at least one of an IP address, soft key, token code, RSA key, ESN, HSM key, MAC address, and a cookie text.

6. The system according to claim 1, wherein the wireless device is a wireless IP device that communicates with the management module using Internet Protocol.

7. The system according to claim 1, wherein the wireless device is built into an automobile.

8. The system according to claim 1, further comprising a monitoring module that monitors financial account transactions to determine the identifier of the financial account that was used to perform the financial transaction in response to the marketing information transmitted to the selected wireless device.

9. The system according to claim 1, wherein the management module generates the tailored marketing information based on the transaction history of the financial account of the received financial account identifier.

10. The system according to claim 1, wherein the management module generates the tailored marketing information based on the purchase history related to a particular merchandise type or category.

11. The system according to claim 1, wherein the management module generates the tailored marketing information based on the residential location of the holder of the financial account.

12. The system according to claim 1, wherein the management module includes in the transmitted marketing information, a unique code to associate the selected wireless device to the received financial account identifier.

13. The system according to claim 12, wherein the management module receives, from a merchant that performs the financial transaction with the user, a transaction authorization request containing the financial account identifier and the unique code.

14. The system according to claim 1, wherein:
the management module determines the location of the selected wireless device; and
generates the tailored marketing information based on personal information derived from the associated financial account identifier and based on the determined location of the selected wireless device.

15. The system according to claim 1, further comprising an issuer marketing database coupled to the management module and storing issuer generated marketing information, wherein the management module generates the tailored marketing information from the data stored in the issuer marketing database.

16. A system for managing tailored marketing to holders of Internet enabled wireless devices adapted to wirelessly access the Internet, the system comprising:
a user database storing a plurality of user data, each user data including a device identifier that identifies an Internet enabled wireless device of a user;
a management module program executable by a processor, the management module being adapted to:
transmit marketing information to a selected wireless device;
receive an identifier of a financial account that was used to perform a financial transaction in response to the marketing information transmitted to the selected wireless device;
store the received financial account identifier in the user database so as to associate the selected wireless device to the received financial account identifier;
after the received financial account identifier is associated with the selected wireless device;
retrieve user information related to the financial account identified by the received financial account identifier; and
generate tailored marketing information for transmission to the selected wireless device based on the retrieved user information.

17. The system according to claim 16, wherein the wireless device identifier is at least one of an IP address, soft key, token code, RSA key, ESN, HSM key, MAC address, and a cookie text.

18. The system according to claim 16, wherein the wireless device is a wireless IP device that communicates with the management module using Internet Protocol.

19. The system according to claim 16, wherein the wireless device is built into an automobile.

20. The system according to claim 16, wherein the management module generates the tailored marketing information based on the transaction history of the financial account identified by the received financial account identifier.

21. The system according to claim 16, further comprising a monitoring module that monitors financial account transactions to determine the identifier of the financial account that was used to perform the financial transaction in response to the marketing information transmitted to the selected wireless device.

22. The system according to claim 16, wherein the management module includes in the transmitted marketing information, a unique code to associate the selected wireless device to the received financial account identifier.

23. The system according to claim 22, wherein the management module receives, from a merchant that performs the financial transaction with the user, a transaction authorization request containing the financial account identifier and the unique code.

24. The system according to claim 16, wherein the management module:
determines the location of the selected wireless device; and
generates the tailored marketing information based on personal information derived from the associated financial account identifier and based on the determined location of the selected wireless device.

25. The system according to claim 16, further comprising an issuer marketing database coupled to the management module and storing issuer generated marketing information, wherein the management module generates the tailored marketing information from the data stored in the issuer marketing database.

26. A method for managing tailored marketing to users of wireless devices adapted to wirelessly access a computer network, the method comprising:
transmitting, through a wireless communication network, marketing information to a selected wireless device;
receiving an identifier of a financial account that was used to perform a financial transaction in response to the marketing information transmitted to the selected wireless device;
storing the received financial account identifier in a user database so as to associate the selected wireless device to the received financial account identifier, the user database storing a plurality of user data with each user data including a user identifier and a device identifier that identifies a wireless device of a user, the association being used to generate tailored marketing information for transmission to the selected wireless device.

27. The method according to claim 26, further comprising:
maintaining a content website on the Internet and transmitting, to the selected wireless device, content selected by the user of the wireless device.

28. The method according to claim 27, further comprising:
allowing the user to log in to the content website using only the user identifier without using a password.

29. The method according to claim 27, when the user of the selected wireless device logs in to the content website using the user identifier and another wireless device other than the selected wireless device, further comprising:
storing in the user database a second device identifier that identifies the another wireless device to associate the financial account identifier to the another wireless device.

30. The method according to claim 26, wherein the wireless device identifier is at least one of an IP address, soft key, token code, RSA key, ESN, HSM key, MAC address, and a cookie text.

31. The method according to claim 26, wherein the wireless device is a wireless IP device and the step of transmitting marketing information includes transmitting the marketing information to the selected wireless device using Internet Protocol.

32. The method according to claim 26, wherein the wireless device is built into an automobile.

33. The method according to claim 26, further comprising monitoring, through a monitoring module, financial account transactions to determine the identifier of the financial account that was used to perform the financial transaction in response to the marketing information transmitted to the selected wireless device.

34. The method according to claim 26, further comprising generating the tailored marketing information based on the transaction history of the financial account identified by the received financial account identifier.

35. The method according to claim 26, further comprising generating the tailored marketing information based on the purchase history related to a particular merchandise type or category.

36. The method according to claim 26, further comprising generating the tailored marketing information based on the residential location of the holder of the financial account.

37. The method according to claim 26, wherein:
the step of transmitting marketing information includes transmitting the marketing information containing a unique code to associate the selected wireless device to the received financial account identifier; and
the method further comprises receiving the unique code contained in a transaction authorization request from a merchant that performed the financial transaction with the user.

38. The method according to claim 26, further comprising:
determining the location of the selected wireless device; and
generating the tailored marketing information based on personal information derived from the associated financial account identifier and based on the determined location of the selected wireless device.

39. The method according to claim 26, further comprising:
storing issuer generated marketing information in an issuer marketing database;
generating the tailored marketing information from the data stored in the issuer marketing database.
